(19) United States
(12) Patent Application Publication
(10) Pub. No.: US 2026/0266741 A1
(43) Pub. Date: Sep. 10, 2026

(54) LASER VISION SENSING DEVICE

(71) Applicant: JLT Co.,LTD., Incheon (KR)

(72) Inventor: Hyun Woo Jeong, Incheon (KR)

(73) Assignee: JLT Co.,LTD., Incheon (KR)

(21) Appl. No.: 19/355,753

(22) Filed: Oct. 10, 2025

(30) Foreign Application Priority Data
Mar. 6, 2025 (KR) 10-2025-0029338
Mar. 6, 2025 (KR) 10-2025-0029340

(51) Int. Cl. G01N 21/956; G01N 21/88

(52) U.S. Cl. CPC G01N 21/95684; G01N 21/8806; G01N 2201/023; G01N 2201/0636; G01N 2201/0638

(57) ABSTRACT

A laser vision sensing device for forming an air curtain includes: a housing forming an internal accommodating space; a laser module disposed in the accommodating space to irradiate a laser beam to a welding object; a camera disposed in the accommodating space spaced apart from the laser module to capture the welding object to which the laser beam has been irradiated; a protective lens member for protecting the camera and the laser module from thermal energy and foreign substances generated during welding; and an air curtain forming member, which forms an air curtain in a space between a front region of the housing, to which the laser module and the camera are oriented, and the welding object, thereby preventing thermal energy and foreign substances generated during welding from penetrating toward the housing.

### CROSS-REFERENCE TO RELATED APPLICATION

This application claims priority to and the benefit of Korean Patent Application Nos. 10-2025-0029338 and 10-2025-0029340 filed on Mar. 6, 2025, the entire contents of which are incorporated herein by reference.

### BACKGROUND

### Technical Field

The present disclosure relates to a laser vision sensing device.

### Discussion of Related Art

One type of non-destructive welding inspection method, the external appearance inspection method, is a method of inspecting the shape of a welding bead generated by welding, including inspection of the length, width, height, and contour of the welding bead.

Among the vision inspection devices used in the conventional external appearance inspection method, 2D image-based inspection devices are widely used for full inspection of welded products because they have advantages such as fast inspection speed. However, such devices have the problem that the lens of the vision inspection device is damaged by dust generated during welding torch operation, or the internal temperature of the vision inspection device increases due to heat generated during welding, thereby causing damage to the vision inspection device.

### SUMMARY

The present disclosure has been devised to solve the above-described problems.

According to one or more embodiments of the present disclosure, by injecting cooling air into the inside of the housing to prevent the internal temperature of the housing from rising due to thermal energy generated during welding or laser beam irradiation, it is possible to minimize or reduce damage to members due to thermal energy generated during device operation.

Further, according to one or more embodiments of the present disclosure, by blowing air toward the laser or camera side to prevent foreign substances such as spatter, dust, debris, or moisture generated during welding from penetrating toward the laser or camera inside the housing, it is possible to minimize or reduce damage to members caused by foreign substances.

In addition, according to one or more embodiments of the present disclosure, the protective lens can be replaced without opening the housing.

According to an embodiment of the present disclosure, a laser vision sensing device for forming an air curtain includes: a housing forming an internal accommodating space; a laser module disposed in the internal accommodating space to irradiate a laser beam to a welding object; a camera disposed in the internal accommodating space spaced apart from the laser module to capture the welding object to which the laser beam has been irradiated; a protective lens member disposed in front of the housing to protect the camera and the laser module from thermal energy and foreign substances generated during welding; and an air curtain forming member, which forms the air curtain in a space between a front region of the housing, to which the laser module and the camera are oriented, and the welding object, thereby preventing thermal energy and foreign substances generated during welding from penetrating toward the housing. The protective lens member is replaceable without disassembling the housing.

The device further includes: a reflecting member disposed in the internal accommodating space to change the path of the laser beam; and a protective window member disposed in front of the housing and comprising a first protective window overlapping with the camera in a first direction and a second protective window overlapping with the laser module in the first direction.

The laser vision sensing device performs inspection of the welding object by moving the camera in a second direction perpendicular to the first direction in which the camera captures the welding object, according to the movement of a welding robot to which the laser vision sensing device is fixedly coupled. The laser module irradiates the laser beam in a fourth direction forming a predetermined angle between the first direction and the second direction and away from the camera. The reflecting member reflects the laser beam in a fifth direction forming a predetermined angle between the first direction and the second direction and toward the camera.

The air curtain forming member is disposed on a first side surface of the protective window member closer to the first protective window than to the second protective window. A distance between the air curtain forming member and the camera is shorter than a distance between the air curtain forming member and the laser module.

The air curtain formed by the air curtain forming member is discharged in a direction toward the reflected laser beam reflected by the reflecting member.

The air curtain forming member includes: a base frame having a polygonal column shape; a vertical through-hole penetrating the upper and lower surfaces of the base frame; a coupling hole communicating with the vertical through-hole and penetrating from a first side surface of the base frame facing the welding object to a second side surface opposite the first side surface; an inlet hole formed in the second side surface, communicating with the vertical through-hole, and configured to introduce air from the inside of the housing into the air curtain forming member; and one or more curtain-forming discharge holes communicating with the vertical through-hole and configured to discharge air inside the air curtain forming member to form an air curtain.

The housing is provided with an inlet for introducing cooling air and an outlet for discharging the cooling air, wherein the outlet is formed in the front surface of the housing where the protective window member is disposed, and the inlet is formed in the rear surface of the housing opposite the front surface.

The inlet hole is disposed at a position corresponding to the outlet of the housing, and a diameter of the one or more curtain-forming discharge holes is smaller than a diameter of the inlet hole.

The base frame further includes: a third side surface connected to the second side surface and in contact with a side surface of the protective window member; a fourth side surface opposite the third side surface; and a fifth side surface connecting the first side surface and the third side surface. The fifth side surface is inclined with respect to the first side surface and the third side surface.

The one or more curtain-forming discharge holes are formed in plurality on the fifth side surface so as to be spaced apart from each other.

An air diffusion portion having a concave shape is formed in a side wall area of the vertical through-hole opposite the inlet hole. The inlet hole is formed in a direction perpendicular to the vertical through-hole. The one or more curtain-forming discharge holes are formed in a direction perpendicular to the vertical through-hole so as to have an inclination angle in a range of 135° to 160° with respect to the inlet hole.

The protective lens member comprises: a first protective lens disposed in a front region of the camera such that the welding object is imaged by the camera; a second protective lens disposed in a front region of the laser module such that the laser beam is irradiated to the welding object; a lens fixing frame configured to fix the first protective lens and the second protective lens; and a protective lens outer frame fixed to a front of the housing in a state in which the lens fixing frame is accommodated therein.

The lens fixing frame includes: a first locking shoulder ring supporting a circumferential region of a front portion of the first protective lens hen the first protective lens is fitted in the first direction; a first opening configured to open or expose a region other than the circumferential region of the front portion of the first protective lens; a second locking shoulder ring supporting a circumferential region of a front portion of the second protective lens when the second protective lens is fitted in the first direction; and a second opening configured to open or expose a region other than the circumferential region of the front portion of the second protective lens.

The protective lens outer frame includes: a lens slot for receiving the lens fixing frame in the second direction in a state in which the first protective lens and the second protective lens are fitted in the first direction; a first outer opening overlapping with the first opening in the first direction to expose the first protective lens; and a second outer opening overlapping with the second opening in the first direction to expose the second protective lens.

In some embodiments, the laser vision sensing device performs inspection of the welding object by moving the camera in a second direction perpendicular to the first direction in which the camera captures the welding object, according to movement of the welding robot to which the laser vision sensing device is fixedly coupled, and the laser beam irradiated by the laser module is a line-shaped laser beam extending in a third direction perpendicular to the first and second directions.

One or more aspects of the present disclosure have been devised to solve the above-described problems, and by arranging the laser at a predetermined inclination angle with respect to the camera and adjusting the traveling direction of the laser using a reflecting member (for example, a mirror), the housing can be designed compactly, thereby reducing the size of the laser vision sensing device.

In addition, by injecting cooling air into the housing during welding or inspection, it is possible to minimize damage to members caused by thermal energy generated during device operation (for example, thermal energy generated during welding or thermal energy generated by laser beam irradiation during inspection).

Furthermore, by blowing air toward the laser or camera side, it is possible to prevent foreign substances such as spatter, dust, debris, or moisture generated during welding from penetrating toward the laser or camera inside the housing, and to minimize damage to members caused by such foreign substances.

### BRIEF DESCRIPTION OF THE DRAWINGS

The above and other objects, features and advantages of the present disclosure should become more apparent to those of ordinary skill in the art by describing embodiments thereof in detail with reference to the accompanying drawings.

FIG. 1 is a perspective view of a welding robot according to some embodiments of the present disclosure.

FIG. 2 is a front perspective view of the welding robot according to some embodiments of the present disclosure, viewed from the front.

FIG. 3 is a rear perspective view of the welding robot according to some embodiments of the present disclosure, viewed from the rear.

FIG. 4 is a schematic front perspective view of the laser vision sensing device according to some embodiments of the present disclosure.

FIG. 5 is a schematic front perspective view of the inside of the housing of the laser vision sensing device according to some embodiments of the present disclosure.

FIG. 6 is a schematic rear perspective view of the inside of the housing of the laser vision sensing device according to some embodiments of the present disclosure.

FIG. 7 is a diagram showing a state in which some components (300, 400, 500, 600) are removed from the laser vision sensing device according to some embodiments of the present disclosure.

FIG. 8 is a sectional view taken along line I-I′ of FIG. 5.

FIG. 9 is a front perspective view of the air curtain forming member according to some embodiments of the present disclosure.

FIG. 10 is a right side perspective view of the air curtain forming member according to some embodiments of the present disclosure.

FIG. 11 is a rear perspective view of the air curtain forming member according to some embodiments of the present disclosure.

FIG. 12 is a sectional view taken along line A-A′ of FIG. 9.

FIG. 13 is a sectional view taken along line B-B′ of FIG. 9.

FIG. 14 is a sectional view taken along line C-C′ of FIG. 9.

FIGS. 15-19 are diagrams for explaining a replaceable protective lens according to some embodiments of the present disclosure, where FIGS. 16 and 17 are sectional views taken along line A-A′ of FIG. 15, and FIG. 18 is a sectional view taken along line B-B′ of FIG. 15.

### DETAILED DESCRIPTION

Hereinafter, embodiments of the present disclosure are described in detail with reference to the accompanying drawings. Advantages and features of the present disclosure and methods of achieving the same should be clearly understood with reference to the following detailed examples. However, the present disclosure is not limited to the examples to be disclosed below but may be implemented in various different forms. The examples are provided in order to fully explain the present disclosure and fully explain the scope of the present disclosure for those having ordinary skill in the art. The scope of the present disclosure is defined by the appended claims. Like reference numerals refer to like elements throughout the specification.

Unless otherwise defined, all terms (including technical and scientific terms) used herein can be used as is customary in the art to which this disclosure belongs. Also, it should be further understood that terms, such as those defined in commonly used dictionaries, should not be interpreted in an idealized or overly formal sense unless expressly so defined herein.

Further, in this specification, the singular forms may include the plural forms unless the context clearly indicates otherwise. It should be understood that the terms “comprise,” “comprising,” “include,” “including,” and/or the like when used herein, specify some stated components, steps, operations and/or elements but do not preclude the presence or addition of one or more other components, steps, operations and/or elements.

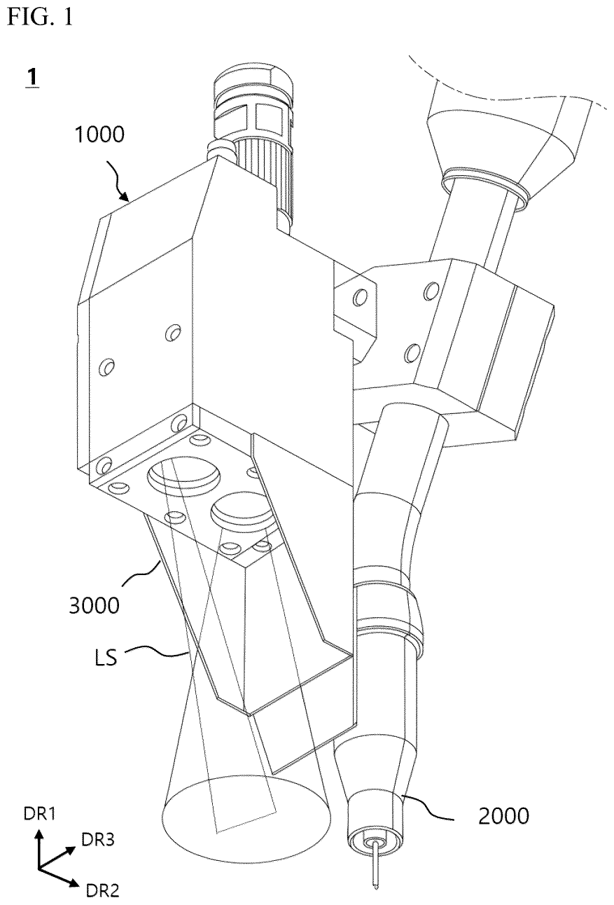

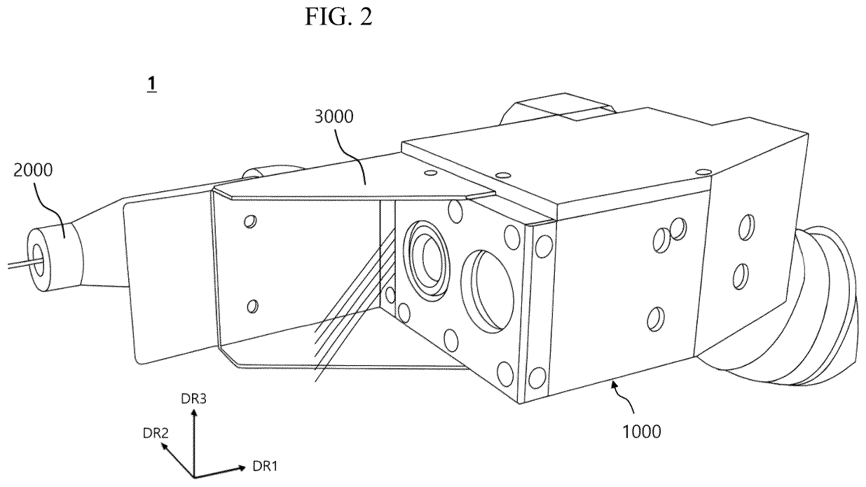

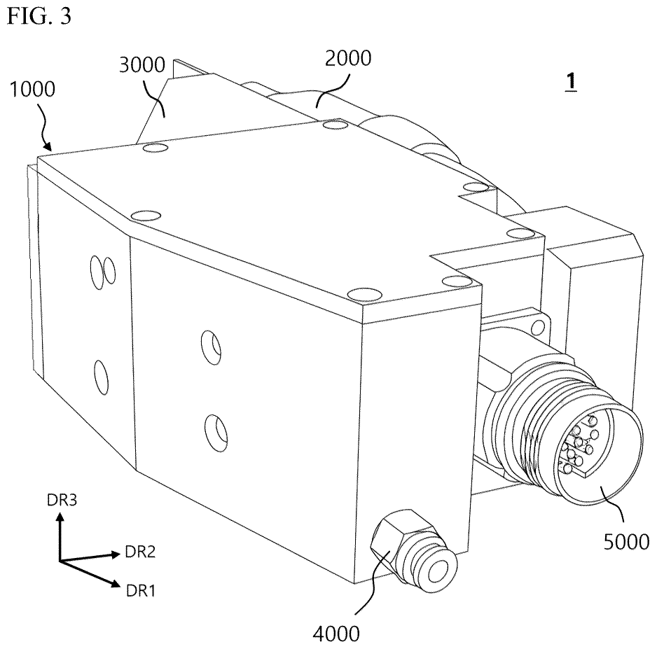

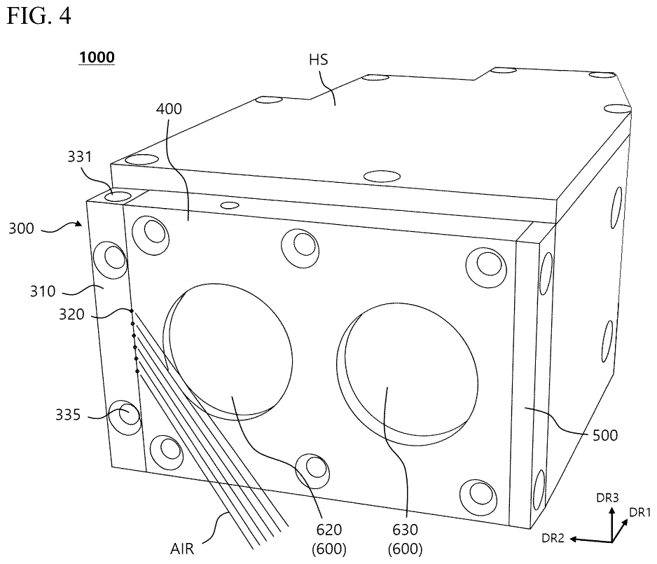

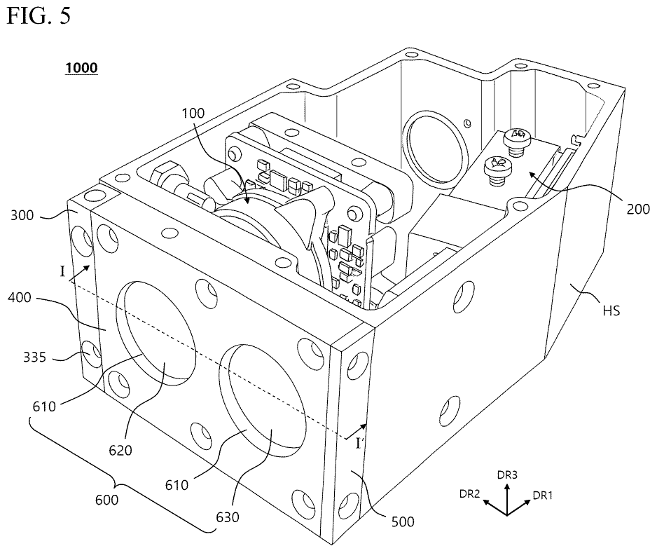

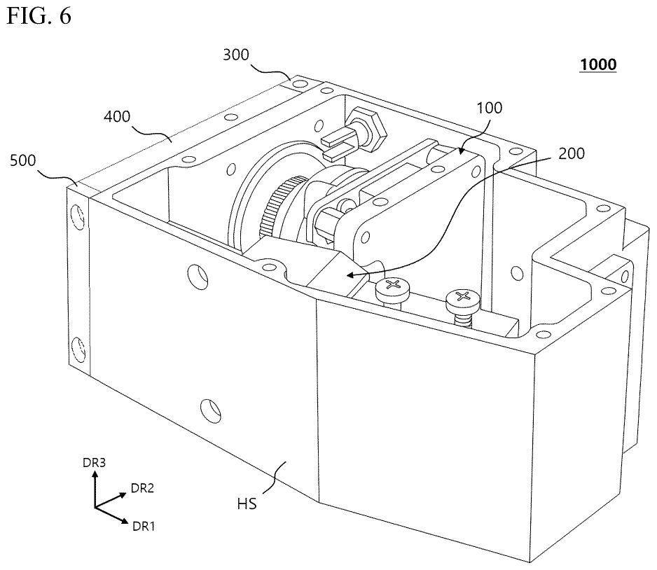

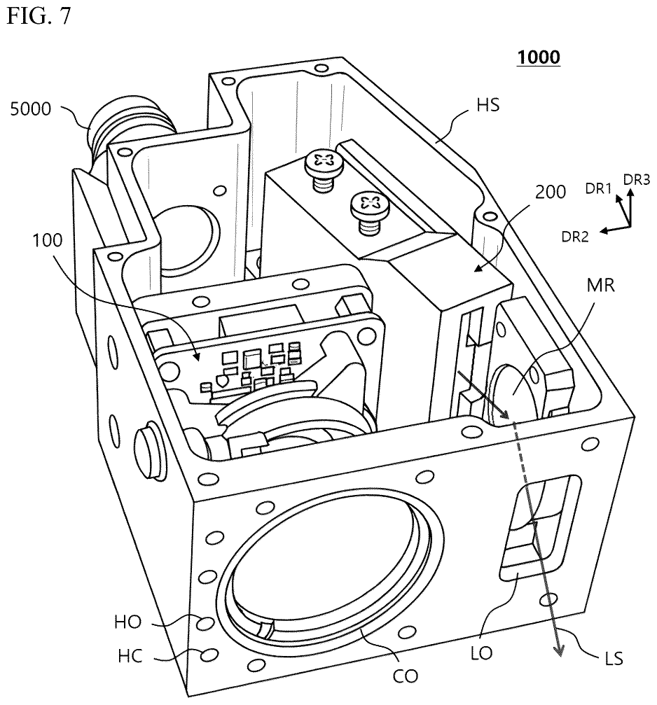

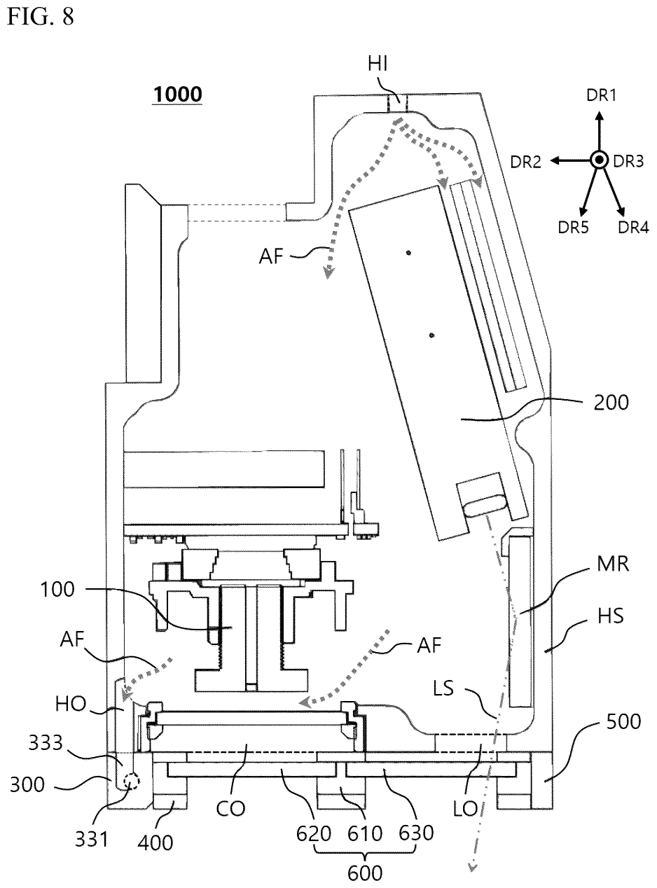

FIG. 1 is a perspective view of a welding robot according to some embodiments of the present disclosure. FIG. 2 is a front perspective view of the welding robot according to some embodiments of the present disclosure, viewed from the front. FIG. 3 is a rear perspective view of the welding robot according to some embodiments of the present disclosure. FIG. 4 is a schematic front perspective view of the laser vision sensing device according to some embodiments of the present disclosure. FIG. 5 is a schematic front perspective view of the inside of the housing of the laser vision sensing device according to some embodiments of the present disclosure. FIG. 6 is a schematic rear perspective view of the inside of the housing of the laser vision sensing device according to some embodiments of the present disclosure. FIG. 7 is a diagram showing a state in which some components (300, 400, 500, 600) are removed from the laser vision sensing device according to some embodiments of the present disclosure. FIG. 8 is a sectional view taken along line I-I′ of FIG. 5.

Referring to FIGS. 1-8, a welding robot (1) according to an embodiment welds a welding portion of a welding object using a welding torch assembly (2000), and can inspect the shape of the welding bead of the welding portion of the welding object using a laser vision sensing device (1000), hereinafter referred to as the “laser vision sensing device”).

In the drawings describing the welding robot (1), the first direction (DR1), the second direction (DR2), and the third direction (DR3) are defined.

The first direction (DR1) is the direction in which the welding object is received or detected by the camera (i.e., the direction in which the camera is oriented), the second direction (DR2) is the moving direction of the welding robot (i.e., the traveling direction of the welding line), and the third direction (DR3) is a direction perpendicular to both the first direction (DR1) and the second direction (DR2) (i.e., the thickness direction of the housing (HS)).

The first direction (DR1) and the second direction (DR2) may be directions perpendicular to each other within one plane. The third direction (DR3) may be a direction perpendicular to the plane in which the first direction (DR1) and the second direction (DR2) are located. The third direction (DR3) forms a perpendicular relationship with each of the first direction (DR1) and the second direction (DR2).

In the embodiments describing the welding robot (1) or the laser vision sensing device (1000), unless otherwise specified, “upper” refers to a direction toward one side of the third direction (DR3), and “upper surface” refers to a surface facing one side of the third direction (DR3). “Lower” refers to a direction toward the other side of the third direction (DR3), and “lower surface” refers to a surface facing the other side of the third direction (DR3). In addition, “left,” “right,” “top,” and “bottom” refer to directions when the laser vision sensing device (1000) is viewed from a plan view (see FIG. 8). For example, “right side” refers to the other side of the second direction (DR2), “left side” refers to one side of the second direction (DR2), “upper side” refers to one side of the first direction (DR1), and “lower side” refers to the other side of the first direction (DR1). When describing the position between the laser vision sensing device (1000) or the welding torch assembly (2000) and the welding object, the direction in which the welding object is placed relative to the laser vision sensing device (1000) or the welding torch assembly (2000) may be referred to as the “front,” and the “front” may refer to the same direction as “the other side of the first direction (DR1), i.e., the lower side.” For convenience of explanation, the terms “front” and “lower side” may be used interchangeably hereinafter.

The welding robot (1) may include the laser vision sensing device (1000), the welding torch assembly (2000), a shielding plate (3000), and a cooling air injection unit (4000). The welding robot (1) may further include a power/control cable connection unit (5000).

The welding torch assembly (2000) may perform a function of irradiating welding light to a welding object using an arc welding torch to weld the welding object. During welding using the welding torch assembly (2000), foreign substances such as dust, spatter, debris, and moisture may be generated at the welding portion, or thermal energy may be generated by the welding light.

The welding torch assembly (2000) may be disposed spaced apart toward the front (or lower side, the other side of the first direction (DR1)) to irradiate welding light toward the welding object so as to weld the welding object. The welding torch assembly (2000) may be disposed on one side of the laser vision sensing device (1000) with the shielding plate (3000) interposed therebetween. The shielding plate (3000) can prevent thermal energy from the welding light irradiated from the welding torch assembly (2000) from being transferred to the laser vision sensing device (1000), and at the same time prevent the optical energy of the welding light from being visible to the camera (100) of the laser vision sensing device (1000).

The laser vision sensing device (1000) may irradiate a laser beam (LS) onto the welding portion and capture the welding portion to inspect the welding bead of the welding portion of the welding object. The laser vision sensing device (1000) may include: a housing (HS) having an internal accommodating space; a laser module (200) emitting the laser beam; a camera (100); a reflecting member (MR); a protective window fixing member (400); a protective window member (600); an air curtain forming member (300); and an opening/closing member (500).

The housing (HS) may be a sealed structure to block foreign substances generated during welding from entering the housing (HS). The accommodating space of the housing (HS) may be provided with the laser module (200), the camera (100), and the reflecting member (MR).

The laser module (200) irradiates the laser beam (LS) toward the welding line where welding has been performed, and the camera (100) may capture a portion of the welding line irradiated with the laser beam and output the captured image.

The laser beam (LS) may be a line laser beam. Specifically, the laser beam (LS) may be a linear laser beam extending in the third direction (DR3).

The laser module (200) may be provided with a separate optical structure such as a slit, a DOE (Diffractive Optical Element), or a cylindrical lens to expand a dot-shaped laser beam emitted from a laser light source into a line shape. However, the laser module (200) itself may be a laser diode capable of emitting in a line shape. In other words, since the laser module (200) emits a line-shaped beam without separate optical components, the structure of the laser vision sensing device (1000) can be simplified and miniaturized.

The camera (100) may be disposed on the left side of the inside the housing (HS). The camera (100) may be arranged to capture toward the lower side toward a welding object disposed spaced apart at the lower side, and may be aligned parallel to the first direction (DR1).

The camera (100) may be, for example, a CCD (Charge Coupled Device) camera or a CMOS (Complementary Metal Oxide Semiconductor) camera.

In some embodiments, the camera (100) may have a measurement resolution of 1 μm to 100 μm or less, and a focal length within about 120 mm to 180 mm, but is not limited thereto.

The laser module (200) may be disposed on the right side inside the housing (HS). Specifically, the laser module (200) may be disposed spaced apart from the camera (100) at the upper right side of the camera (100) inside the housing (HS).

The laser module (200) may be arranged to be inclined at a predetermined angle with respect to the camera (100) arranged to capture toward the lower side. Specifically, the distance between one end of the laser module (200) from which the laser beam is irradiated and the camera (100) may be greater than the distance between the other end of the laser module (200) and the camera (100). In other words, the laser module (200) may be arranged so that the other end is inclined toward the camera (100). The one end of the laser module (200) from which the laser is irradiated may be positioned to be inclined away from the camera (100). In this case, the length in the first direction (DR1) of the space in which the laser module (200) is positioned at the upper right side of the camera (100) inside the housing (HS), and the length protruding in the second direction (DR2), may be shorter than in the case where the laser module (200) is arranged in parallel along the first direction (DR1). Accordingly, the volume of the housing (HS) accommodating the camera (100) and the laser module (200) can be reduced, thereby achieving miniaturization of the product.

The reflecting member (MR) can perform the function of adjusting the incidence angle of the laser beam. The laser beam irradiated from the laser module (200) arranged inclined with respect to the first direction (DR1) can have its incidence angle toward the welding object adjusted by the reflecting member (MR). The reflecting member (MR) may be implemented as a mirror.

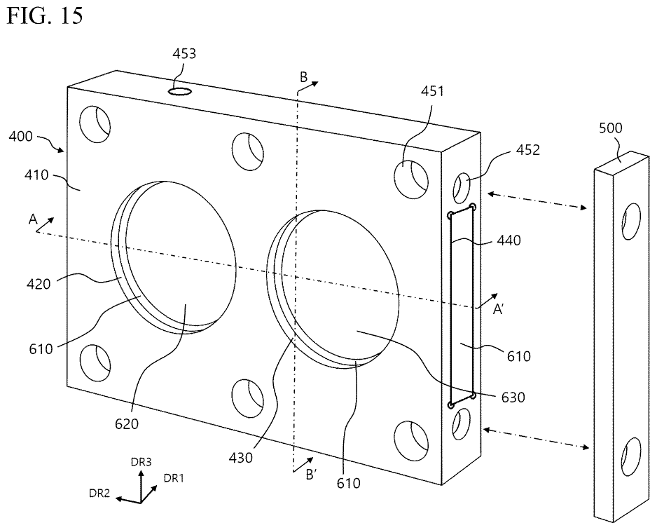

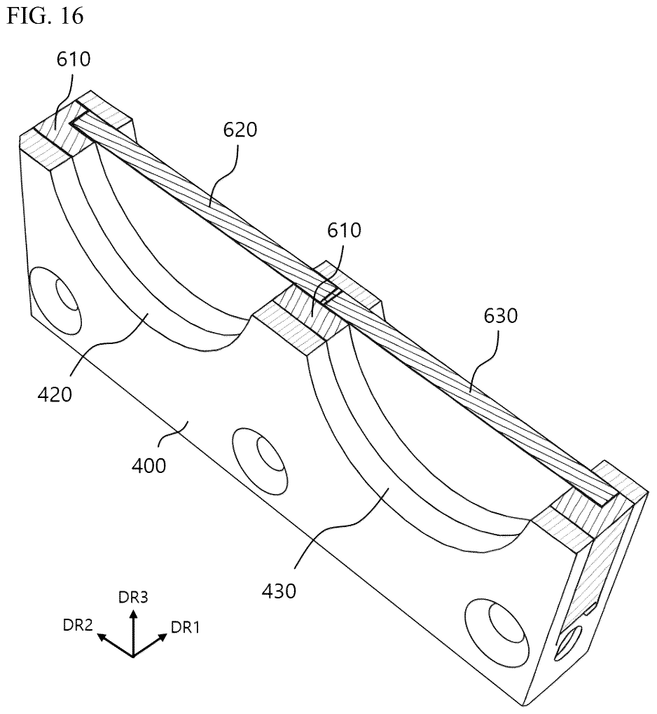

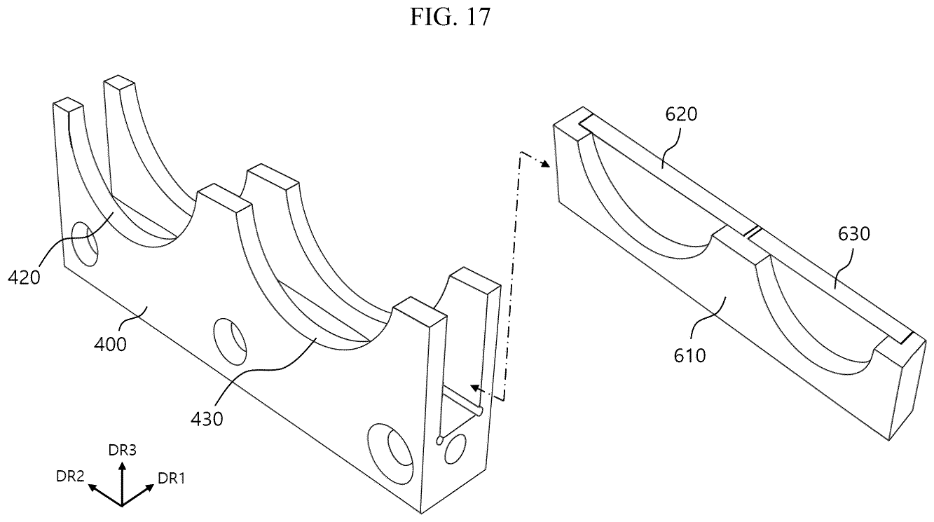

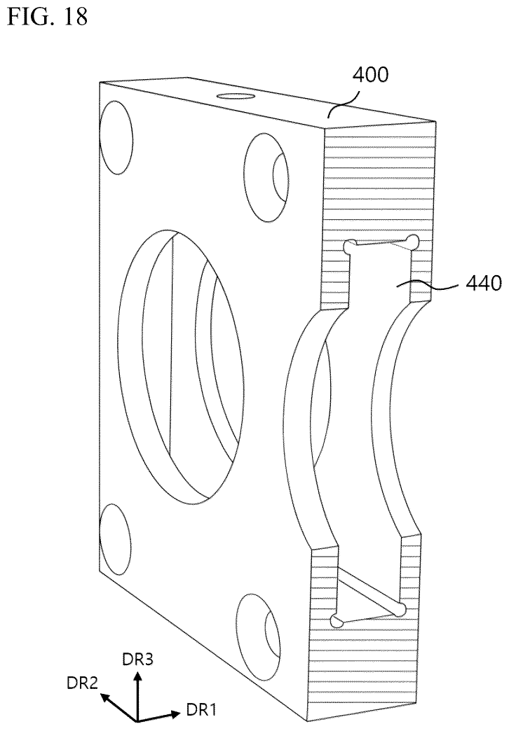

FIGS. 15-19 are diagrams for illustrating a replaceable protective lens according to some embodiments of the present disclosure. FIGS. 16 and 17 are sectional views taken along line A-A′ of FIG. 15 and FIG. 18 is a sectional view taken along line B-B′ of FIG. 15.

Referring to FIGS. 15-19 , a protective lens member (400) and an air curtain forming member (300) may be disposed at the front of the housing (HS). The protective lens member (400) and the air curtain forming member (300) can perform a function of preventing foreign substances generated during welding from penetrating into the inside of the housing (HS), thereby protecting the camera (100), the laser module (200), and the reflecting member (MR).

Specifically, the protective lens member (400) may be configured to include: a first protective lens (620) disposed in a front area of the camera (100) so that a welding target is imaged; a second protective lens (630) disposed in a front area of the laser module (200) so that a laser beam is irradiated onto the welding target; a lens fixing frame (610) for fixing the first protective lens (620) and the second protective lens (630); and a protective lens outer frame (410), which is fixedly coupled to the front of the housing (HS) in a state in which the lens fixing frame (610) is accommodated therein.

On the right side of the protective lens member (400), an opening/closing member (500) may be disposed. Depending on whether the opening/closing member (500) is detached or mounted, the right slot (440) of the protective lens member (400) may be opened or closed. The protective lenses (620, 630) damaged by foreign substances generated during welding may be replaced by removing the opening/closing member (500) and opening the right side of the protective lens member (400). Accordingly, the work of separately opening the housing (HS) to replace the protective lenses (620, 630) can be omitted, thereby reducing the cost and time required for the replacement work.

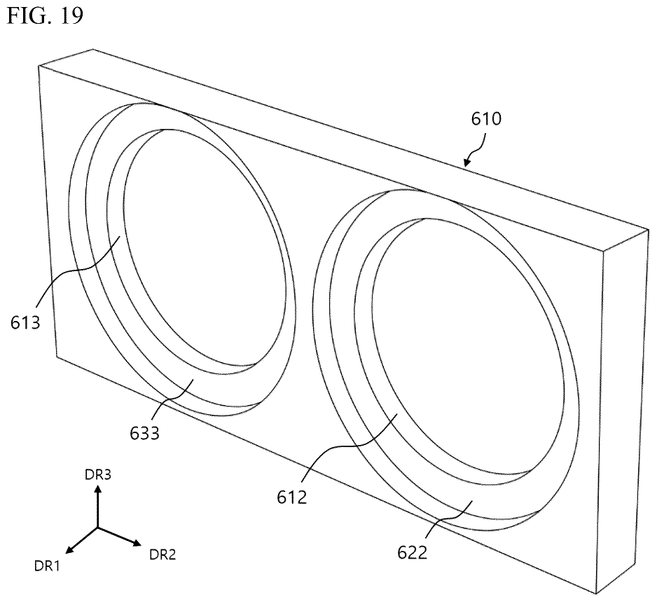

As shown in FIG. 19, the lens fixing frame (610) may be configured to include: a first locking step ring (622) for supporting the circumferential area of the front portion of the first protective lens (620) when the first protective lens (620) is fitted in a first direction (DR1); a first opening (612) for opening or exposing an area other than the circumferential area of the front portion of the first protective lens (620); a second locking step ring (633) for supporting the circumferential area of the front portion of the second protective lens (630) when the second protective lens (630) is fitted in the first direction (DR1); and a second opening (613) for opening or exposing an area other than the circumferential area of the front portion of the second protective lens (630).

The protective lens outer frame (410) may be configured to include: a lens slot (440) for receiving the lens fixing frame (610) in a second direction (DR2) in a state in which the first protective lens (620) and the second protective lens (630) are fitted in the first direction (DR1); a first outer opening (420), which overlaps with the first opening (612) in the first direction (DR1) and opens the first protective lens (620); and a second outer opening (430), which overlaps with the second opening (613) in the first direction (DR1) and opens the second protective lens (630).

As shown in FIG. 15, the protective lens outer frame (410) may be provided with: a first coupling hole (451) for fixing the protective lens outer frame (410) to the housing (HS); a second coupling hole (452) for fixing the opening/closing member (500) to prevent the lens fixing frame (610) inserted into the slot (440) from being separated; and a third coupling hole (453) for fixing the shield plate (3000) to the welding robot (1).

The first coupling hole (451) may be formed in a front portion of the protective lens outer frame (410), the second coupling hole (452) may be formed in a right side portion of the protective lens outer frame (410) where the slot (440) is located, and the third coupling hole (453) may be formed in the upper and lower end surfaces of the protective lens outer frame (410).

The third coupling hole (453) may be directly coupled to the housing (HS), but in view of the ease of attaching/detaching the shield plate (3000) in industrial environments, such as changing the specifications of the shield plate (3000) depending on the specifications of the welding robot, it is advantageous that the third coupling hole (453) is coupled to the protective lens outer frame (410) as illustrated.

The air curtain forming member (300) may be disposed on the left side of the protective lens member (400) (i.e., in an area close to the welding torch assembly (2000)). The air curtain forming member (300) may be disposed on the left side of the protective lens member (400) and spray air toward the protective lens member (400) to form an air curtain (AIR). The direction of travel of the air curtain (AIR) may be a lower-right direction on a plane (i.e., toward the camera-side protective lens (620) and the laser-side protective lens (630) from an area adjacent to the welding torch assembly (2000)). The air curtain forming member (300) may perform a function of preventing foreign substances generated in front from flowing toward the protective lenses (620, 630) by forming an air curtain (AIR) toward the front of the protective lens member (400).

The air curtain forming member (300) may be disposed adjacent to one side in the second direction (DR2) of the protective lens member (400). The air curtain forming member (300) may, as described later, draw in cooling air from inside the housing (HS) to form an air curtain (AIR) toward the front of the protective lens member (400). By means of the air curtain (AIR), foreign substances generated during welding that would otherwise flow toward the protective lens member (400) or the front of the housing (HS) are blocked, and components inside the housing (HS) (e.g., the camera (100) or the laser module (200)) can be prevented from being damaged by foreign substances.

Hereinafter, the flow of cooling air (AF) introduced into the inside of the housing (HS) using the cooling air injection unit (4000) and the air curtain forming member (300) that draws in the cooling air (AF) from inside the housing (HS) to form the air curtain (AIR) is described.

As shown in FIGS. 7 and 8, the housing (HS) may be formed with an air inlet (HI), an air outlet (HO), a coupling hole (HC), a camera opening (CO), and a laser opening (LO).

Specifically, the housing (HS) may be formed with an inlet (HI) for introducing cooling air (AF) to allow the cooling air (AF) to flow inside the housing (HS), and an outlet (HO) for discharging the cooling air (AF) to the air curtain forming member (300). The inlet (HI) may be formed in the rear surface of the housing (HS), and the outlet (HO) may be formed in the front surface of the housing (HS) overlapping the air curtain forming member (300). The cooling air injection unit (4000) is installed at the inlet (HI), and cooling air is introduced from the outside into the inside of the housing (HS) through the cooling air injection unit (4000) so that cooling air (AF) can flow inside the housing (HS). As the cooling air (AF) flows inside the housing (HS), it is possible to prevent components disposed inside the housing (HS) from deteriorating and being damaged or malfunctioning due to the internal temperature of the housing (HS) rising from thermal energy generated during welding using the welding torch assembly (2000) or thermal energy generated during the operation of the camera (100) or the laser module (200). Accordingly, economic efficiency for maintenance of the laser vision sensing device (1000) can be ensured.

In addition, the housing (HS) may be formed with a coupling hole (HC) (see FIG. 7) for fixedly coupling the air curtain forming member (300) to the housing (HS). The coupling hole (HC) may be formed at a position corresponding to the coupling hole (335) of the air curtain forming member (300). The air curtain forming member (300) may be fixed to the housing (HS) by a bolt or the like inserted into the coupling hole (HC) through the coupling hole (335).

The outlet (HO) formed in the front of the housing (HS) may communicate with the inlet hole (333) and the vertical through-hole (331) of the air curtain forming member (300) described later. The cooling air (AF) may flow from the inlet (HI) of the housing (HS) to the outlet (HO) of the housing (HS) to form a cooling air flow (AF), and may be introduced into the inlet hole (333) and the vertical through-hole (331) of the air curtain forming member (300) communicating with the outlet (HO). The cooling air (AF) introduced into the air curtain forming member (300) may be discharged from the air curtain forming member (300) to form the air curtain (AIR).

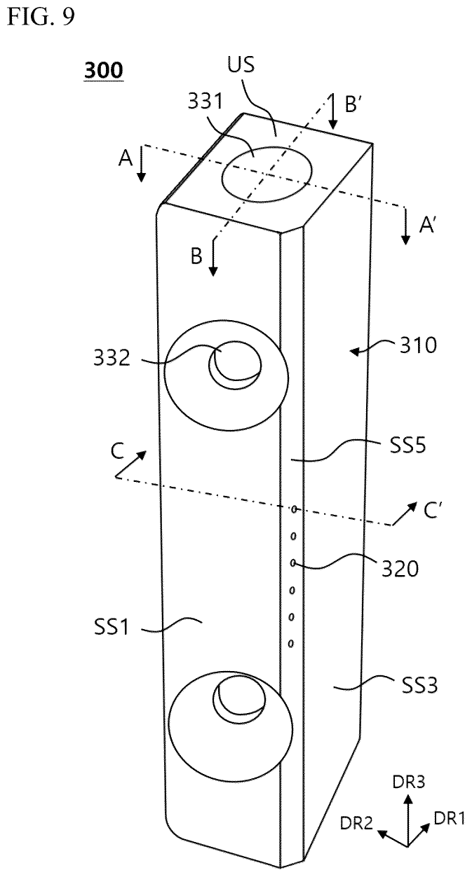

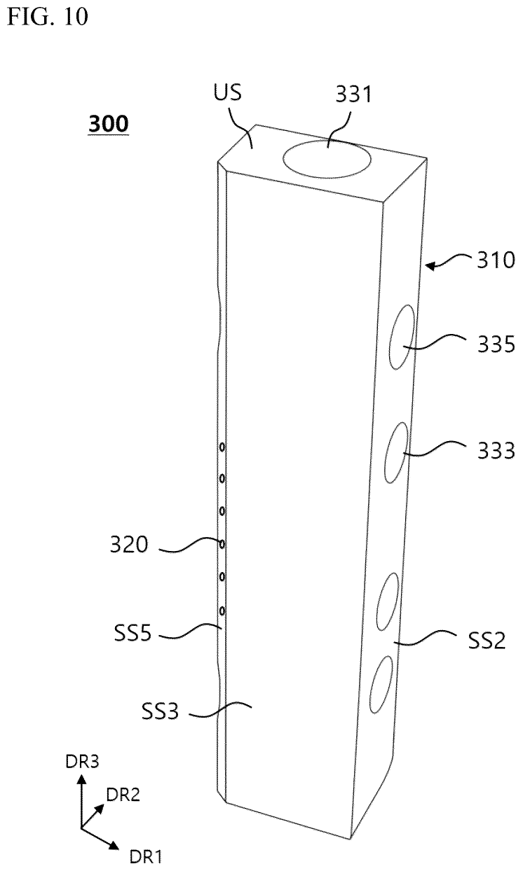

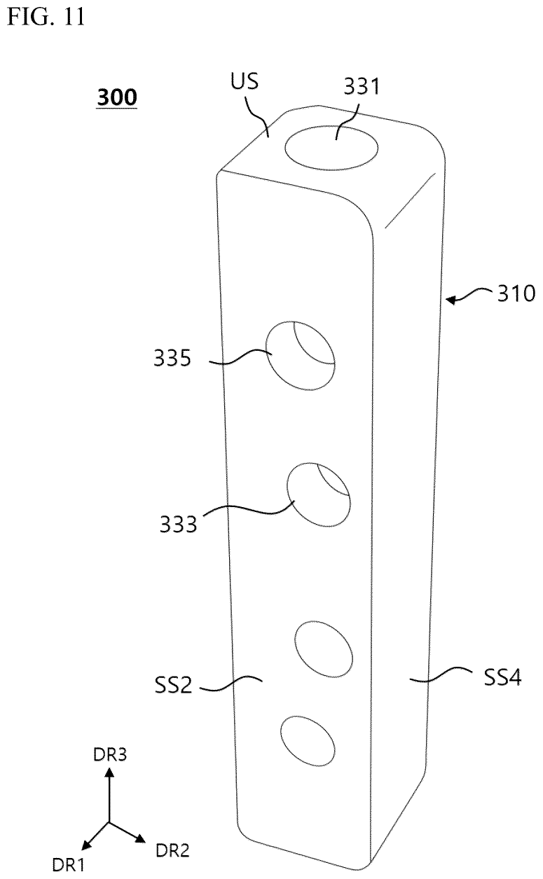

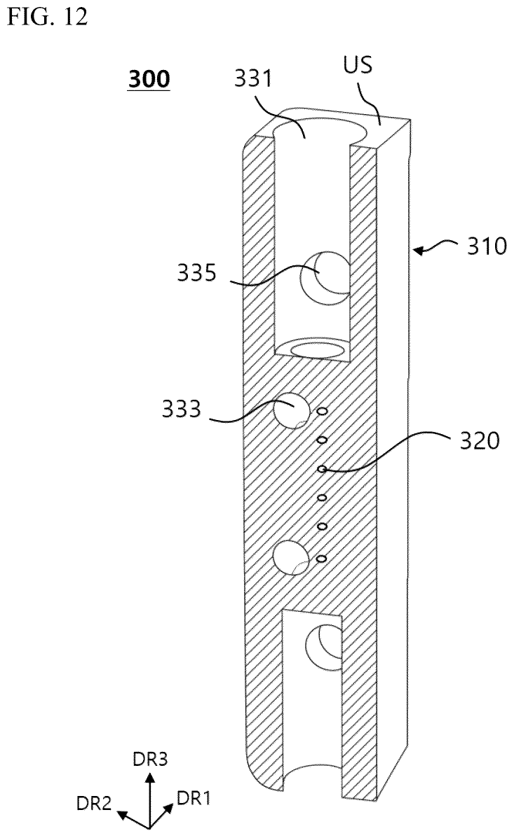

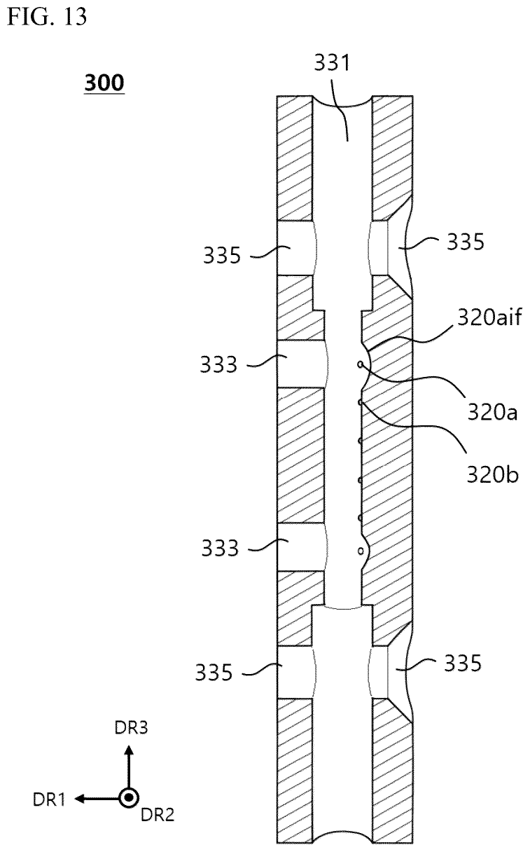

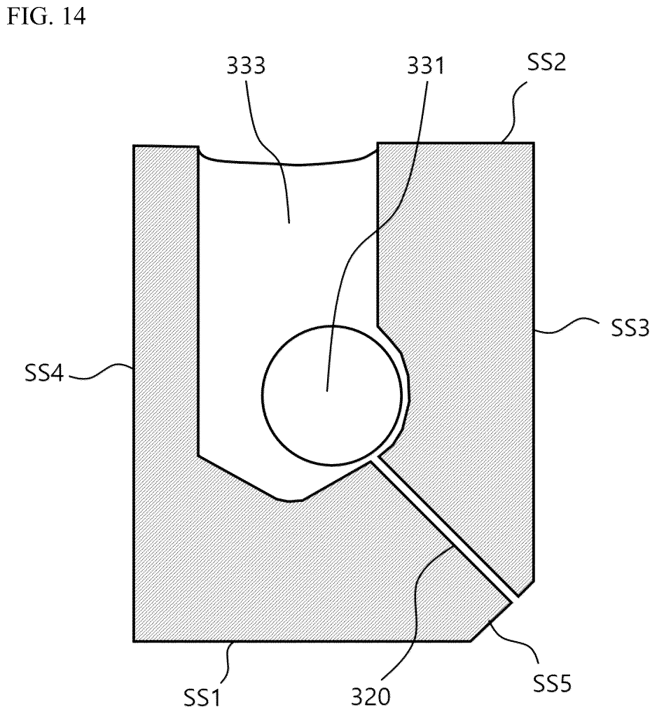

FIG. 9 is a front perspective view of the air curtain forming member according to some embodiments of the present disclosure. FIG. 10 is a right-side perspective view of the air curtain forming member according to some embodiments of the present disclosure. FIG. 11 is a rear perspective view of the air curtain forming member according to some embodiments of the present disclosure. FIG. 12 is a sectional view taken along line A-A′ of FIG. 9. FIG. 13 is a sectional view taken along line B-B′ of FIG. 9. FIG. 14 is a sectional view taken along line C-C′ of FIG. 9.

Referring to FIGS. 9-14 , the air curtain forming member (300) may include a base frame (310), a vertical through-hole (331) penetrating the base frame (310) in the third direction (DR3), an inlet hole (333), and curtain-forming discharge holes (320).

The air curtain forming member (300) may further include a coupling hole (335). The coupling hole (335) may be a groove in which a coupling member for mutually coupling the housing (HS) and the air curtain forming member (300) is engaged. For this purpose, the coupling hole (335) may be formed to penetrate from one side surface (SS1) of the base frame (310) in the first direction (DR1) to the other side surface (SS2).

The base frame (310) may have a predetermined shape so that the air curtain (AIR) formed by air discharged from the air curtain forming member (300) is directed toward the front of the protective window member (600) at a predetermined angle. Specifically, the base frame (310) may include an upper surface (US), a lower surface opposite the upper surface, a first side surface (SS1) facing the front, a second side surface (SS2) opposite the first side surface, a third side surface (SS3) facing to the right between the first side surface and the second side surface, a fourth side surface (SS4) opposite the third side surface, and a fifth side surface (SS5) disposed between the first side surface and the third side surface. Accordingly, the upper and lower surfaces may be formed as pentagons.

The first side (SS1) and the third side (SS3) are perpendicular to each other, and the fifth side (SS5) may be formed to be inclined with respect to the first side and the third side. The fifth side (SS5) may have an inclination angle of 135° to 160° with respect to the first side.

In addition, the inlet hole (333) may be formed in a direction perpendicular to the vertical through-hole (331), and the curtain-forming discharge hole (320) may be formed in a direction perpendicular to the vertical through-hole (331), and may be formed to have an inclination angle in a range of 135° to 160° with respect to the inlet hole (333).

When formed within the range of the inclination angle, the inflow of foreign substances by the air curtain (AIR) formed by the curtain-forming discharge hole (320) formed on the fifth side (SS5) can be effectively prevented.

The vertical through-hole (331) may be formed to penetrate the upper surface and the lower surface of the base frame (310) in the third direction (DR3).

Referring additionally to FIG. 8, the inlet hole (333) may be formed in the first direction (DR1) on the second side (SS2) of the base frame (310). Specifically, the inlet hole (333) is formed on the second side (SS2) of the base frame (310) so as to correspond to the outlet (HO) of the housing (HS).

The inlet hole (333) may be in communication with the vertical through-hole (331) and may be arranged to be in communication with the outlet (HO) formed in the front surface of the housing (HS). Accordingly, the cooling air (AF) inside the housing (HS) is discharged through the outlet (HO) and can have an airflow flowing into the vertical through-hole (331) through the inlet hole (333).

The curtain-forming discharge hole (320) may be formed on the fifth side (SS5). The curtain-forming discharge hole (320) may be formed in plurality spaced apart along the third direction (DR3) on the fifth side (SS5). The curtain-forming discharge hole (320) may be formed to penetrate the fifth side (SS5) so as to be in communication with the vertical through-hole (331). Accordingly, the cooling air (AF) transferred to the vertical through-hole (331) may be discharged through the curtain-forming discharge hole (320) to form the air curtain (AIR).

The diameter of the curtain-forming discharge hole (320) may be smaller than the diameter of the inlet hole (333). By forming the diameter of the curtain-forming discharge hole (320) smaller than the diameter of the inlet hole (333), the pressure of the air discharged from the curtain-forming discharge hole (320) is increased, so that the inflow of foreign substances can be effectively prevented.

Furthermore, in order for the air introduced from the housing (HS) to be delivered to the curtain-forming discharge hole (320) without interference from a bolt fastened to the coupling hole (335), and at the same time to maintain an appropriate hydraulic pressure inside the air curtain-forming member (300), it is advantageous that the diameter of the vertical through-hole (331) in the region where the coupling hole (335) is formed is larger than the diameter of the vertical through-hole (331) in the region where the curtain-forming discharge hole (320) and the inlet hole (333) are formed (see FIG. 13).

So that the air introduced through the inlet hole (333) is evenly diffused inside the air curtain-forming member (300), a concave-shaped air diffusion part (320aif) may be formed in the sidewall region of the vertical through-hole (331) opposite the inlet hole (333).

In the air curtain-forming member (300) according to the present disclosure, since the inlet hole (333) and the curtain-forming discharge hole (320) are in communication with each other through the vertical through-hole (331) penetrating in the third direction (DR3), it is possible to omit precision design connecting the inlet hole (333) and the curtain-forming discharge hole (320) during the manufacturing of the air curtain-forming member (300) to allow the cooling air to flow from the inlet hole (333) to the curtain-forming discharge hole (320), thereby simplifying the manufacturing design of the air curtain-forming member (300) and improving the efficiency of the manufacturing process.

In addition, in order to prevent the heat energy and foreign substances generated during welding from penetrating toward the housing (HS) without degrading the vision inspection performance, it is advantageous that the air curtain (AIR) formed by the air curtain-forming member (300) is discharged in a direction approaching the laser beam (LS) reflected by the reflecting member (MR).

The laser vision sensing device (1000) may inspect the welding target by moving in the second direction (DR2) perpendicular to the first direction (DR1) in which the camera (100) photographs the welding target, according to the movement of the welding robot (1) to which the laser vision sensing device is fixedly coupled. The laser module (200) irradiates the laser beam (LS) in a fourth direction (DR4) forming a predetermined angle between the first direction and the second direction and moving away from the camera, and the reflecting member (MR) reflects the laser beam (LS) in a fifth direction (DR5) forming a predetermined angle between the first direction (DR1) and the second direction (DR2) and approaching the camera (100). The air curtain-forming member (300) is disposed on the first side of the protective window member (600) closer to the first protective window (620) than to the second protective window (630), so that the distance between the air curtain-forming member (300) and the camera (100) is closer than the distance between the air curtain-forming member (300) and the laser module (200).

The camera opening (CO) is a circular opening formed at a position corresponding to the lens of the camera (100), and the laser opening (LO) is an opening formed to have a rectangular shape to emit the line laser reflected from the reflecting member (MR) toward the inspection object.

The laser vision sensing device (1000) according to the present disclosure omits an additional member for generating air for forming the air curtain (AIR) to prevent the inflow of foreign substances, and forms the air curtain (AIR) using the cooling air (AF) or the cooling air flow (AF) introduced to lower the temperature inside the housing (HS), thereby reducing the manufacturing cost of the laser vision sensing device (1000).

What is claimed is:

1. A laser vision sensing device, comprising:
a housing forming an internal accommodating space;
a laser module disposed in the internal accommodating space to irradiate a laser beam to a welding object;
a camera disposed in the internal accommodating space and spaced apart from the laser module to capture the welding object to which the laser beam has been irradiated;
a protective lens member disposed in front of the housing to protect the camera and the laser module from thermal energy and foreign substances generated during welding; and
an air curtain forming member, which forms an air curtain in a space between a front region of the housing, to which the laser module and the camera are oriented, and the welding object, thereby preventing thermal energy and foreign substances generated during welding from penetrating toward the housing,
wherein the protective lens member is replaceable without disassembling the housing.

2. The laser vision sensing device according to claim 1, further comprising:
a reflecting member disposed in the internal accommodating space to change a path of the laser beam; and
a protective window member disposed in front of the housing and comprising a first protective window overlapping with the camera in a first direction and a second protective window overlapping with the laser module in the first direction,
wherein the laser vision sensing device is configured to perform inspection of the welding object by moving the camera in a second direction perpendicular to the first direction in which the camera captures the welding object, according to movement of a welding robot to which the laser vision sensing device is fixedly coupled,
wherein the laser module is configured to irradiate the laser beam in a fourth direction forming a predetermined angle between the first direction and the second direction and away from the camera,
wherein the reflecting member is configured to reflect the laser beam in a fifth direction forming a predetermined angle between the first direction and the second direction and toward the camera,
wherein the air curtain forming member is disposed on a first side surface of the protective window member closer to the first protective window than to the second protective window,
wherein a distance between the air curtain forming member and the camera is shorter than a distance between the air curtain forming member and the laser module, and
wherein the air curtain formed by the air curtain forming member is discharged in a direction toward the reflected laser beam reflected by the reflecting member.

3. The laser vision sensing device according to claim 2, wherein the air curtain forming member comprises:
a base frame having a polygonal column shape;
a vertical through-hole penetrating upper and lower surfaces of the base frame;
a coupling hole communicating with the vertical through-hole and penetrating from a first side surface of the base frame facing the welding object to a second side surface opposite the first side surface;
an inlet hole formed in the second side surface, communicating with the vertical through-hole and configured to introduce air from an inside of the housing into the air curtain forming member; and
one or more curtain-forming discharge holes communicating with the vertical through-hole and configured to discharge air inside the air curtain forming member to form an air curtain,
wherein the housing is provided with an inlet for introducing cooling air and an outlet for discharging the cooling air, the outlet being formed in a front surface of the housing where the protective window member is disposed, and the inlet being formed in a rear surface of the housing opposite the front surface,
wherein the inlet hole is disposed at a position corresponding to the outlet of the housing, and
wherein a diameter of the one or more curtain-forming discharge holes is smaller than a diameter of the inlet hole.

4. The laser vision sensing device according to claim 3, wherein the base frame further comprises:
a third side surface connected to the second side surface and in contact with a side surface of the protective window member;
a fourth side surface opposite the third side surface; and
a fifth side surface connecting the first side surface and the third side surface,
wherein the fifth side surface is inclined with respect to the first side surface and the third side surface,
wherein the one or more curtain-forming discharge holes are formed in plurality on the fifth side surface so as to be spaced apart from each other,
wherein an air diffusion portion having a concave shape is formed in a side wall area of the vertical through-hole opposite the inlet hole,
wherein the inlet hole is formed in a direction perpendicular to the vertical through-hole, and
wherein the one or more curtain-forming discharge holes are formed in a direction perpendicular to the vertical through-hole so as to have an inclination angle in a range of 135° to 160° with respect to the inlet hole.

5. The laser vision sensing device according to claim 4, wherein the protective lens member comprises:
a first protective lens disposed in a front region of the camera such that the welding object is imaged by the camera;
a second protective lens disposed in a front region of the laser module such that the laser beam is irradiated to the welding object;
a lens fixing frame configured to fix the first protective lens and the second protective lens; and
a protective lens outer frame fixed to a front of the housing in a state in which the lens fixing frame is accommodated therein,
wherein the lens fixing frame includes
a first locking shoulder ring supporting a circumferential region of a front portion of the first protective lens hen the first protective lens is fitted in the first direction,
a first opening configured to expose a region other than the circumferential region of the front portion of the first protective lens,
a second locking shoulder ring supporting a circumferential region of a front portion of the second protective lens when the second protective lens is fitted in the first direction, and
a second opening configured to expose a region other than the circumferential region of the front portion of the second protective lens, and
wherein the protective lens outer frame includes
a lens slot for receiving the lens fixing frame in the second direction in a state in which the first protective lens and the second protective lens are fitted in the first direction,
a first outer opening overlapping with the first opening in the first direction to expose the first protective lens, and
a second outer opening overlapping with the second opening in the first direction to expose the second protective lens.
